(19) United States
(12) Patent Application Publication
(10) Pub. No.: US 2006/0155948 A1
(43) Pub. Date: Jul. 13, 2006

(54) Semiconductor memory system and method for data transmission

(76) Inventor: Hermann Ruckerbauer, Moos (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/259,452

(22) Filed: Oct. 26, 2005

(30) Foreign Application Priority Data
Oct. 27, 2004 (DE) 10 2004 052 268.5

(51) Int. Cl. G06F 13/28

(52) U.S. Cl. 711/167

(57) ABSTRACT

A semiconductor memory system is proposed, in which the transmission of memory data of a burst that follows command/address data of a write/read command is identified by means of a modified clock signal. The modified clock signal has identifying regions with masked-out clock edges, so that the transmission of memory data can be signalled with the clock edge following the identifying regions.

### CROSS-REFERENCE TO RELATED APPLICATIONS

This Utility Patent Application claims priority to German Patent Application No. DE 10 2004 052 268.5, filed on Oct. 27, 2004, which is incorporated herein by reference.

### BACKGROUND

One embodiment of the invention relates to a semiconductor memory system having a memory controller and a semiconductor memory and to a method for transmitting memory data between the memory controller and the semiconductor memory. In one case, the transmission of the memory data of a burst is signalled by means of a clock signal.

In future memory generations, synchronization between command/address data (CA) and memory data (DQ) will become increasingly difficult since the length of a unit interval (UI) of a bit of memory data (DQ) will become less than the expected variation range of the clock signal of the command/address data. By way of example, a length of the unit interval of a bit of memory data of just 156 ps is to be expected in the future memory generation DDR4. Accordingly, finding a first memory bit of a data burst with temporal reference to a read or write command is very difficult. The high data transmission rates in future memory generations make it difficult even to recognize the first or last memory bit of a data burst.

Present-day memory generations such as DDR2-SDRAMs, for example, utilize a bidirectional data stroke signal DQS for identifying the start and end of a data burst and also for achieving a correct data flow between memory controller and semiconductor memory. For future memory generations with even higher data transmission rates, a free-running clock signal is desired in some cases on account of its higher accuracy in comparison with a data stroke signal. However, a free-running clock signal cannot be used to identify either the start or the end of a data burst. A further concept for identifying a data burst utilizes the transmission of additional signals with information on the envelope of the data burst. However, this concept entails a further pin has to be provided at the memory controller and the semiconductor memory.

### SUMMARY

One embodiment of the invention provides a semiconductor memory system and a method for data transmission in a semiconductor memory system that uses a modified clock signal for identifying the transmission of data bursts.

In one embodiment, the semiconductor memory system has a memory controller and a semiconductor memory for transmitting command/address data (CA) from the memory controller to the semiconductor memory, memory data (DQ) between the memory controller and the semiconductor memory, and also a clock signal (CLK) from at least the memory controller to the semiconductor memory. The clock signal alternating between a lowest and a highest signal value by means of rising and falling clock edges has identifying regions with masked-out clock edges which are situated temporally downstream of a write/read command for memory data and signal the transmission of a first bit of the memory data of a burst with the clock edge following the identifying region. Consequently, this signal contains, besides the clock information, additional information for identifying a data burst, thereby providing synchronization between the command/address data (CA) and the memory data (DQ).

In one embodiment, the burst of memory data is assigned a further identifying region in the clock signal, which serves for signalling the end of the burst with the clock edge following the further region. Accordingly, the clock signal with the identifying region situated temporally downstream of a write/read command for memory data and also the further identifying region for signalling the end of the burst has the information of a burst envelope.

In a further embodiment the identifying regions have the lowest signal value by the masking out of a rising and a falling clock edge and the transmission of the memory data of a burst is signalled with a rising clock edge. In this case, a circuit block recognizes the missing clock edges and utilizes the subsequent rising clock edge for synchronization. The masking-out of only one rising and one falling clock edge avoids a shortest possible configuration of the identifying region.

As an alternative to this, in a further embodiment, the identifying region has the highest signal value by the masking out of a falling and a rising clock edge, so that the transmission of the memory data of a burst is signalled with a falling clock edge. Accordingly, the start of the transmission of memory data of the burst can also be clocked with a falling edge, which is comparable with the clocking of individual data bits of a burst with a falling clock edge in a DDR2 semiconductor memory system.

In a further embodiment of the invention, the identifying regions have the lowest signal value by the masking out of a plurality of rising and falling clock edges, so that the transmission of the memory data of the burst is signalled with a rising clock edge. In this embodiment, the temporal length of the identifying region is no longer minimal as in the case of masking out only one rising and one falling clock edge. In this case, however, the identifying regions can be detected better in terms of circuitry at very high data transmission rates.

As an alternative to this, in a further embodiment, the identifying regions have the highest signal value by the masking out of a plurality of falling and a plurality of rising clock edges, so that the transmission of the memory data of a burst is signalled with a falling clock edge.

In one case, the identifying region which is situated temporally downstream of a write/read command for memory data in the clock signal has the lowest signal value, the further identifying region having the highest signal value. As a result, the start/end of the transmission of memory data of a burst with an even number of data bits can be clocked with a rising/falling edge.

As an alternative to this, in a further embodiment, the identifying region which is situated temporally downstream of a write/read command for memory data in the clock signal has the highest signal value, and the further identifying region has the lowest signal value.

In one case, the clock signal is formed as a free-running clock signal in order to enable clocking and synchronization that are as accurate as possible particularly at very high data transmission rates of future memory generations.

In one embodiment, the masked-out clock edges of the identifying regions in the clock signal can be recovered by means of a phase-locked loop circuit in the semiconductor memory. In contrast to a delay-locked loop (DLL) circuit, which cannot be used to recover the masked-out clock edges of the identifying regions, a phase-locked loop circuit does not recognize an individual masked-out edge, but rather generates a slight noise in the clock signal.

A further embodiment of the invention provides for the clock signal to be transmitted between the memory controller and the semiconductor memory. The clock signal can thus be transmitted both from the memory controller to the semiconductor memory and from the semiconductor memory to the memory controller.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a schematic illustration of a semiconductor memory system, in particular of the DDR2 memory generation.

FIG. 2 illustrates the profile of signals of a first embodiment.

FIG. 3 illustrates the profile of signals of a further embodiment.

FIG. 4 illustrates the profile of signals of a further embodiment.

FIG. 5 illustrates the profile of signals of a further embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

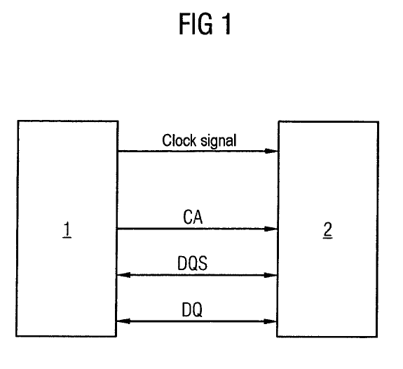

FIG. 1 illustrates a schematic illustration of component parts of a semiconductor memory system of the DDR2 memory generation. A clock signal and also command/address data CA are transmitted from the memory controller 1 to the semiconductor memory. A bidirectional data strobe signal DQS is transmitted with the memory data DQ in semiconductor memory systems of the DDR2 memory generation and signals to the semiconductor memory 2 or the memory controller 1 the transmission of memory data DQ to be written or read.

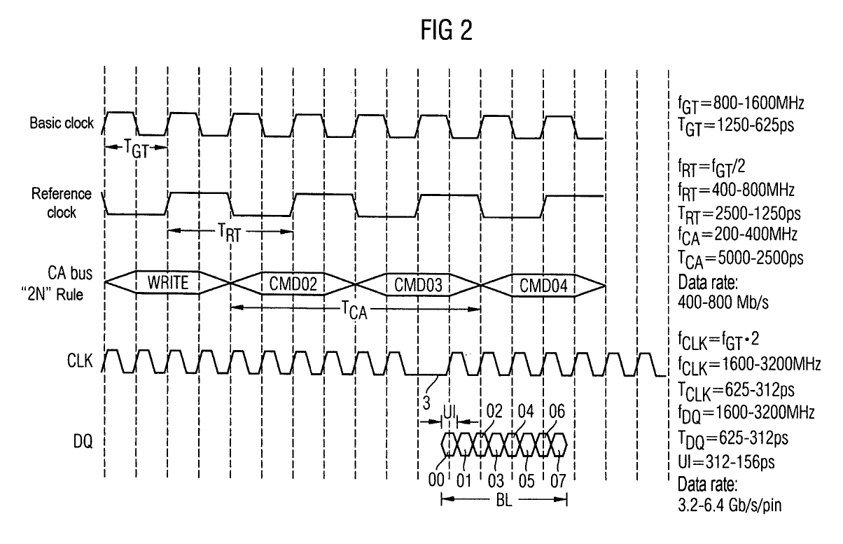

FIG. 2 schematically illustrates the profile of signals of a first embodiment with exemplary signal value ranges of a future memory generation such as DDR4, for instance. Besides a basic clock signal having the period duration T_{GT} in the range of 1250 to 625 ps (frequency f_{GT}=800-1600 MHz), provision is made of a reference clock signal having the period duration T_{RT} in the range of 2500 to 1250 ps (frequency f_{RT}=f_{GT}/2=400-800 MHz. In the clock signal CLK, an identifying region 3 is situated temporally downstream of a write (WRITE) command on a command/address (CA) bus. A period duration of command/address data in the range of 5000-2500 ps with the “2N” rule enables data transmission rates in the range of 400-800 Mb/s. The clocking for the transmission of the memory data of the burst having a length BL is effected with the rising clock edge following the identifying region 3 and is thus in temporal relationship with the write (WRITE) command on the command/address (CA) bus. A period duration T_{CLK} in the range of 625 to 312 ps (frequency F_{CLK} in the range of 1600-3200 MHz) enables data transmission rates of memory data in the range of 3.2-6.4 Gb/s/pins. A use interval UI of a bit of memory data is 312-156 ps, for example, given transmission with double transmission rate (DDR) and a period duration T_{DQ} of memory data DQ in the range of 625-312 ps (frequency F_{DQ}=1600-3200 MHz).

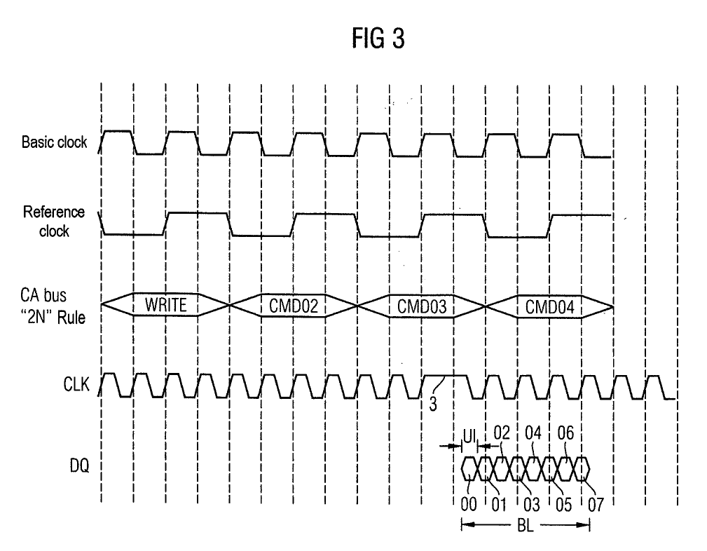

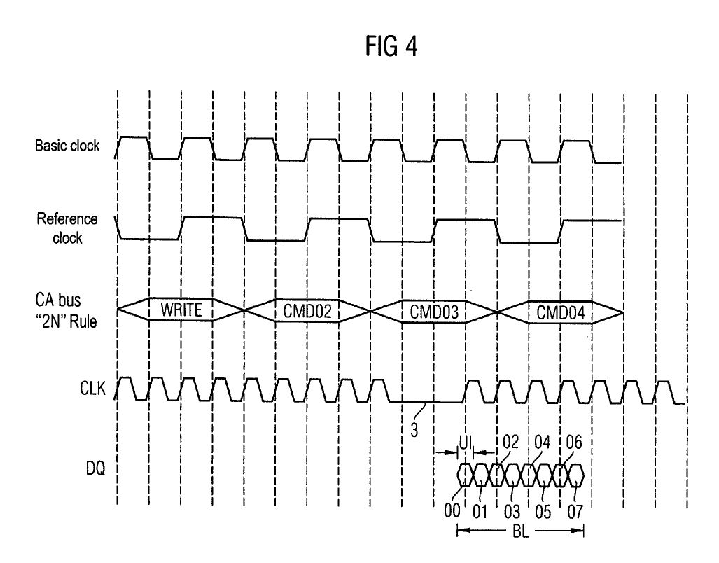

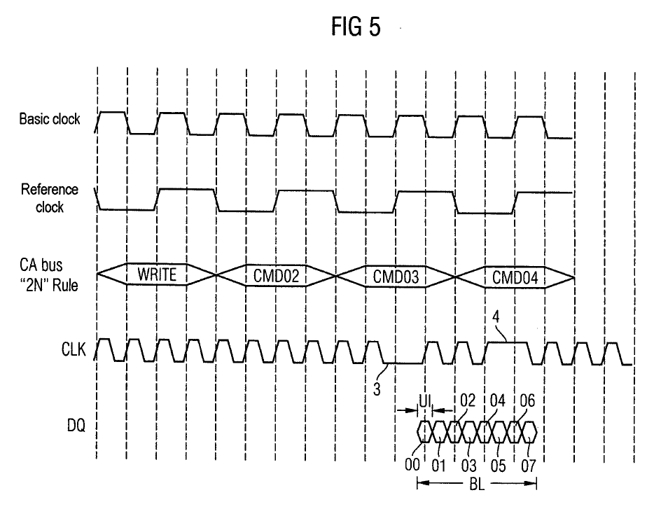

FIG. 3 illustrates the temporal profile of signals of a further embodiment of the invention. The value ranges and definitions of the signals which are presented by way of example in FIG. 2 and the description thereof are also valid for FIG. 3 and the subsequent FIGS. 4 and 5. The identifying region 3 in the clock signal CLK which is situated temporally downstream of the write (WRITE) command on the CA bus has the highest signal value by the masking out of a falling and a rising clock edge. The clocking of the memory data of the burst of data DQ is effected with the falling clock edge subsequent to the identifying region 3 and is thus in temporal relationship with the write (WRITE) command on the CA bus.

FIG. 4 schematically illustrates the temporal profile of signals of one embodiment of the invention. The identifying region 3 in the clock signal CLK which follows the write (WRITE) command on the CA bus has the lowest signal value by the masking out of a plurality of rising and falling clock edges, so that the transmission of the memory data DQ of the burst is signalled with the subsequent rising clock edge. The masking out of a plurality of rising and falling edges makes it possible, in the semiconductor memory, to effect better circuitry detection of the identifying region 3 at very high data transmission rates of future memory generations.

FIG. 5 schematically illustrates the temporal profile of signals of a further embodiment of the invention. Definitions and exemplary value ranges of the signals can be gathered from the figure description of FIG. 2. An identifying region 3 in the clock signal CLK is situated temporally downstream of a write (WRITE) command on the CA bus, which region has the lowest signal value by the masking out of a rising and a falling clock edge. The transmission of the memory data of the burst is signalled with the rising clock edge subsequent to the identifying region 3. The burst of memory data DQ is assigned a further identifying region 4 in the clock signal CLK, which is situated temporally downstream of the identifying region 3. The further identifying region 4 in the clock signal CLK serves for signalling the end of the burst. The further identifying region 4 has the highest signal value by the masking out of a falling and a rising clock edge, the end of the burst of memory data DQ being clocked with the falling edge following the identifying region 4. The identifying regions 3 and 4 thus provide the information of an envelope of the burst of memory data DQ in the clock signal CLK.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A semiconductor memory system having a memory controller and a semiconductor memory, the memory system comprising:
command/address data that can be transmitted from the memory controller to the semiconductor memory;
memory data that can be transmitted between the memory controller and the semiconductor memory;
a clock signal that can be transmitted at least from the memory controller to the semiconductor memory and alternates between a lowest and a highest signal value by means of rising and falling clock edges;
wherein the clock signal has identifying regions with masked-out clock edges;
wherein an identifying region in the clock signal is situated temporally downstream of a write/read command for memory data; and
wherein the transmission of a first bit of the memory data of a burst can be signalled with the clock edge following the identifying region.

2. The semiconductor memory system of claim 1, wherein the burst of memory data is assigned a further identifying region in the clock signal, and wherein the end of the burst can be signalled with the clock edge following the further region.

3. The semiconductor memory system of claim 1, wherein the identifying regions have the lowest signal value by the masking out of a rising and a falling clock edge, and wherein the transmission of the memory data of a burst can be signalled with a rising clock edge.

4. The semiconductor memory system of claim 1, wherein the identifying regions have the highest signal value by the masking out of a falling and a rising clock edge, and wherein the transmission of the memory data of a burst can be signalled with a falling clock edge.

5. The semiconductor memory system of claim 1, wherein the identifying regions have the lowest signal value by the masking out of a plurality of rising and falling clock edges, and wherein the transmission of the memory data of a burst can be signalled with a rising clock edge.

6. The semiconductor memory system of claim 1, wherein the identifying regions have the highest signal value by the masking out of a plurality of falling and rising clock edges, and wherein the transmission of the memory data of a burst can be signalled with a falling clock edge.

7. The semiconductor memory system of claim 2, wherein the identifying region which is situated temporally downstream of a write/read command for memory data in the clock signal has the lowest signal value, and wherein the further identifying region has the highest signal value.

8. The semiconductor memory system of claim 2, wherein the identifying region, which is situated temporally downstream of a write/read command for memory data in the clock signal, has the highest signal value, and wherein the further identifying region has the lowest signal value.

9. The semiconductor memory system of claim 1, wherein the clock signal is a modified free-running clock signal.

10. The semiconductor memory system of claim 1, wherein the masked-out clock edges of the identifying regions in the clock signal can be recovered by means of a phase-locked loop circuit in the semiconductor memory.

11. The semiconductor memory system of claim 1, wherein the clock signal can be transmitted between the memory controller and the semiconductor memory.

12. A method for data transmission between a memory controller and a semiconductor memory, comprising:
transmitting command/address data from the memory controller to the semiconductor memory;
transmitting memory data between the memory controller and the semiconductor chip;
alternating a clock signal between a lowest and a highest signal value by means of transmitting rising and falling clock edges at least from the memory controller to the semiconductor memory;
masking out clock edges in identifying regions in the clock signal;
situating an identifying region in the clock signal temporally downstream of a write/read command for memory data; and
signalling the transmission of a first bit of the memory data of a burst with the clock edge following the identifying region.

13. The method of claim 12 further comprising assigning the burst of memory data a further identifying region in the clock signal and signalling the end of the burst with the clock edge following the further region.

14. The method of claim 12 further comprising masking out a rising and a falling clock edge such that the identifying regions have the lowest signal value and signalling the transmission of the memory data of a burst with a rising clock edge.

15. The method of claim 12 further comprising masking out a falling and a rising clock edge such that the identifying regions have the highest signal value and signalling the transmission of the memory data of a burst with a falling clock edge.

16. The method of claim 12 further comprising masking out a plurality of rising and falling clock edges such that the identifying regions have the lowest signal value and signalling the transmission of the memory data of a burst with a rising clock edge.

17. The method of claim 12 further comprising masking out a plurality of falling and rising clock edges, such that the identifying regions have the highest signal value and signalling the transmission of the memory data of a burst can be signalled with a falling clock edge.

18. The method of claim 13, wherein the identifying region, which is situated temporally downstream of a write/read command for memory data in the clock signal, has the lowest signal value, and wherein the further identifying region has the highest signal value.

19. The method of claim 13, wherein the identifying region, which is situated temporally downstream of a write/read command for memory data in the clock signal, has the highest signal value, and wherein the further identifying region has the lowest signal value.

20. The method of claim 12, wherein the clock signal is a modified free-running clock signal.

21. The method of claim 12, wherein the masked-out clock edges of the identifying regions in the clock signal can be recovered by means of a phase-locked loop circuit in the semiconductor memory.

22. The method of claim 12 further comprising transmitting the clock signal between the memory controller and the semiconductor memory.

23. A semiconductor memory system having a memory controller and a semiconductor memory comprising:
means for transmitting memory data between the memory control and the semiconductor memory;
means for transmitting a clock signal from the memory controller to the semiconductor memory, the clock signal alternating between a lowest and highest signal value by means of rising and falling clock edges;
means for masking out clock edges in identifying regions in the clock signals;
means for situating an identifying region in the clock signal temporally downstream of a write/read command for memory data; and
means for signaling the transmission of a first bit of memory data of a burst with the clock edge following the identifying region.
